(19) United States
(12) Patent Application Publication
(10) Pub. No.: US 2024/0008381 A1
(43) Pub. Date: Jan. 11, 2024

(54) AGRICULTURAL SYSTEM AND ASSEMBLY FOR SUPPORTING A DRAWBAR OF AN AGRICULTURAL VEHICLE

(71) Applicant: CNH Industrial America LLC, New Holland, PA (US)

(72) Inventors: John Rasset, Barnesville, MN (US); Timothy Hertsgaard, Fargo, ND (US)

(21) Appl. No.: 17/858,623

(22) Filed: Jul. 6, 2022

(51) Int. Cl. A01B 59/042

(52) U.S. Cl. CPC A01B 59/042

(57) ABSTRACT

An agricultural system for supporting a drawbar of an agricultural vehicle includes a drawbar hanger couplable to a rear frame of the agricultural vehicle, with the drawbar hanger defining an opening along a longitudinal direction. The agricultural system further includes a drawbar extending between a proximal end and a distal end along the longitudinal direction, the proximal end being receivable in the opening defined by the drawbar hanger, and the distal end being couplable to the rear frame. Additionally, the agricultural system includes an adjustable stop member receivable within a slot defined within one of the drawbar hanger or the drawbar. The adjustable stop member is selectively movable within the slot to allow the adjustable stop member to be brought into contact with the other of the drawbar hanger or the drawbar.

### FIELD OF THE INVENTION

The present disclosure relates generally to work vehicles and, more particularly, to agricultural systems and assemblies for supporting a drawbar of an agricultural work vehicle, such as a tractor.

### BACKGROUND OF THE INVENTION

Agricultural work vehicles, such as tractors, harvesters, etc., are commonly used to perform a variety of agricultural tasks (e.g., to tow planters or seeders for planting seeds, to tow spraying implements for applying fertilizer, to tow tillage implements for tillage operations, for harvesting agricultural product, etc.). Typically, towed implements are attached to the work vehicle by a hitch or drawbar assembly at the rear end of the work vehicle. For instance, a drawbar may be coupled at a first end to a frame of the work vehicle and at a second end to an implement to be towed. The second end of the drawbar may generally be supported at the rear end of the work vehicle by a drawbar hanger. In some instances, a safety chain may be coupled between the drawbar hanger and the towed implement in case the towed implement unintentionally uncouples from the second end of the drawbar.

If the drawbar hanger hits the ground and/or if the towed implement suddenly uncouples from the drawbar, a force is applied to the drawbar hanger by the ground or by the towed implement via the safety chain. The force applied by the ground or the safety chain may cause the drawbar hanger to torque, which can damage the drawbar hanger. If the drawbar hanger is damaged beyond a certain extent, the drawbar hanger has to be replaced, which can be expensive.

Accordingly, an improved agricultural system and assembly for supporting a drawbar of an agricultural vehicle would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural system for supporting a drawbar of an agricultural vehicle. The agricultural system may include a drawbar hanger couplable to a rear frame of the agricultural vehicle, with the drawbar hanger defining an opening along a longitudinal direction. The agricultural system may further include a drawbar extending between a proximal end and a distal end along the longitudinal direction, with the proximal end being receivable in the opening defined by the drawbar hanger, and with the distal end being couplable to the rear frame. Additionally, the agricultural system may include an adjustable stop member receivable within a slot defined within one of the drawbar hanger or the drawbar. The adjustable stop member may be selectively movable within the slot to allow the adjustable stop member to be brought into contact with the other of the drawbar hanger or the drawbar.

In another aspect, the present subject matter is directed to an assembly for supporting a drawbar of an agricultural vehicle. The assembly may include a drawbar hanger configured to be fixed relative to a rear frame of the agricultural vehicle, with the drawbar hanger comprising a bar support portion and a saddle portion. The saddle portion may be fixed to the bar support portion such that an opening along a longitudinal direction is formed between the saddle portion and the bar support portion for receiving a drawbar of the agricultural vehicle. The assembly may further include an adjustable stop member receivable within a slot defined within the saddle portion. The adjustable stop member may be selectively movable within the slot to allow the adjustable stop member to be brought into contact with a drawbar when a drawbar is received within the opening.

Additionally, in one aspect, the present subject matter is directed to an agricultural system for supporting a drawbar of an agricultural vehicle. The agricultural system may include a drawbar hanger couplable to a rear frame of the agricultural vehicle, with the drawbar hanger comprising a bar support portion and a saddle portion. The saddle portion may be fixed to the bar support portion such that an opening is formed along the longitudinal direction between the saddle portion and the bar support portion. Additionally, the agricultural system may include a drawbar extending between a proximal end and a distal end along the longitudinal direction, with the proximal end being receivable in the opening formed between the saddle portion and the bar support portion, and with the distal end being couplable to the rear frame. The proximal end of the drawbar may at least partially overlap a longitudinal end surface of the drawbar hanger in both a lateral direction and a vertical direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of a work vehicle in accordance with aspects of the present subject matter;

FIG. 2 illustrates a perspective view of a rear end of an agricultural work vehicle having a drawbar support assembly for supporting a drawbar in accordance with aspects of the present subject matter, particularly illustrating adjustable stop assemblies for protecting a drawbar hanger of the drawbar support assembly;

FIGS. 3 and 4 illustrate further perspective views of the drawbar support assembly shown in FIG. 2 in accordance with aspects of the present subject matter, particularly illustrating the drawbar having adjustable stops for supporting a drawbar hanger of the drawbar support assembly; and

FIGS. 5 and 6 illustrate various views of another embodiment of a drawbar support assembly in accordance with aspects of the present subject matter, particularly illustrating a drawbar hanger of the drawbar support assembly having adjustable stops for protecting the drawbar hanger.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to agricultural systems and assemblies for supporting a drawbar of an agricultural work vehicle, such as a tractor. Particularly, a drawbar hanger may be supported at a rear end of the work vehicle, where the drawbar hanger includes a laterally extending bar support portion, and a saddle portion fixed to the bar support portion such that an opening for receiving a drawbar of the work vehicle is formed along the front-rear direction of the work vehicle between the bar support and saddle portions. Additionally, the drawbar and/or the drawbar hanger may have one or more adjustable stop members that allow the drawbar and the drawbar hanger to be in contact along the front-rear direction of the work vehicle. As such, if the drawbar hanger hits the ground during travel, any forces applied to the drawbar hanger by the ground that would otherwise typically result in a torsional force on the drawbar hanger can, instead, be transferred to the drawbar to prevent damage to the drawbar hanger. Similarly, if the drawn implement uncouples from the drawbar, any forces applied to the drawbar hanger by a safety chain coupled between the drawbar hanger and the implement that would otherwise typically result in a torsional force on the drawbar hanger can, instead, be transferred to the drawbar to prevent damage to the drawbar hanger.

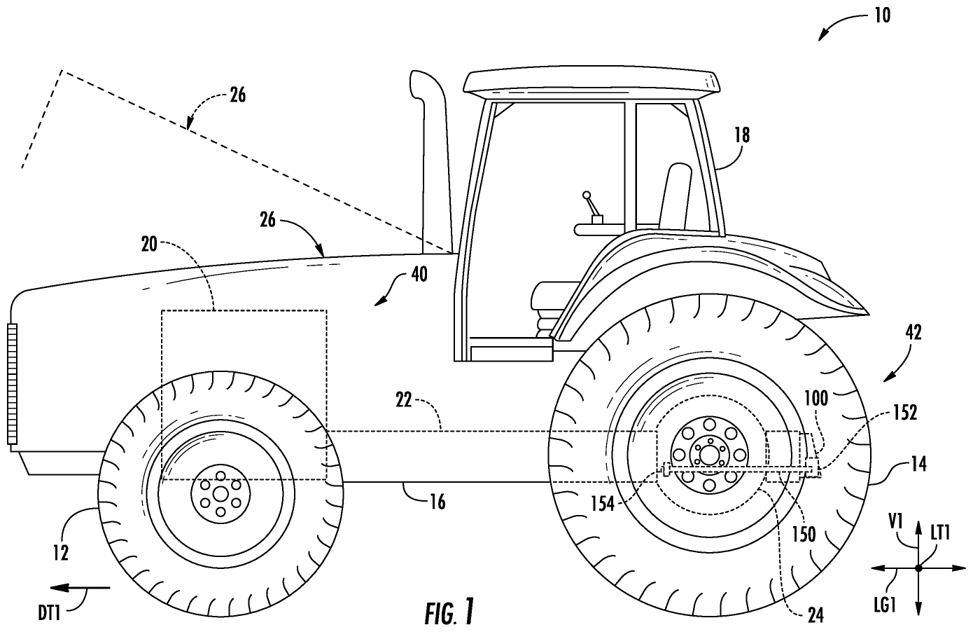

Referring now to the drawings, FIG. 1 illustrates one embodiment of a work vehicle 10 in accordance with aspects of the present subject matter. In particular, FIG. 1 illustrates a side view of the work vehicle 10. It should be appreciated that, although the work vehicle 10 illustrated herein is configured as an agricultural tractor, the work vehicle 10 may generally be configured as any suitable work vehicle known in the art, such as various other agricultural vehicles, earth-moving vehicles, road vehicles, loaders and/or the like.

As shown in FIG. 1, the work vehicle 10 includes a pair of front wheels 12, a pair or rear wheels 14, and a chassis or frame 16 coupled to and supported by the wheels 12, 14. An operator's cab 18 may be supported by a portion of the frame 16 and may house various control devices (not shown) for permitting an operator to control the operation of the work vehicle 10. Additionally, the work vehicle 10 may include an engine 20 and a transmission 22 mounted on the frame 16. The transmission 22 may be operably coupled to the engine 20 and may provide variably adjusted gear ratios for transferring engine power to the wheels 12, 14 via a differential 24. In some embodiments, the work vehicle 10 is configured as a four-wheel drive vehicle, where the front and rear wheels 12, 14 are all driven by the engine 20 and transmission 22. However, in other embodiments, the work vehicle 10 is configured as a two-wheel drive, where only the front wheels 12 or only the rear wheels 14 are driven by the engine 20 and transmission 22.

The work vehicle 10 may also include a hood 26 configured to least partially surround and/or cover the various under-hood components stored within the vehicle's engine compartment 40, such as the engine 20 and any other suitable under-hood components (e.g., hydraulic components, pneumatic components, electrical components, mechanical component(s), storage tank(s), etc.). As particularly shown in FIG. 1, the hood 26 may be configured to be pivotally coupled to a portion of the work vehicle 10 at or adjacent to its aft or rear end such that the hood 26 can be pivoted about the aft end between a closed position (shown in solid lines in FIG. 1) and an opened position (shown in dashed lines in FIG. 1).

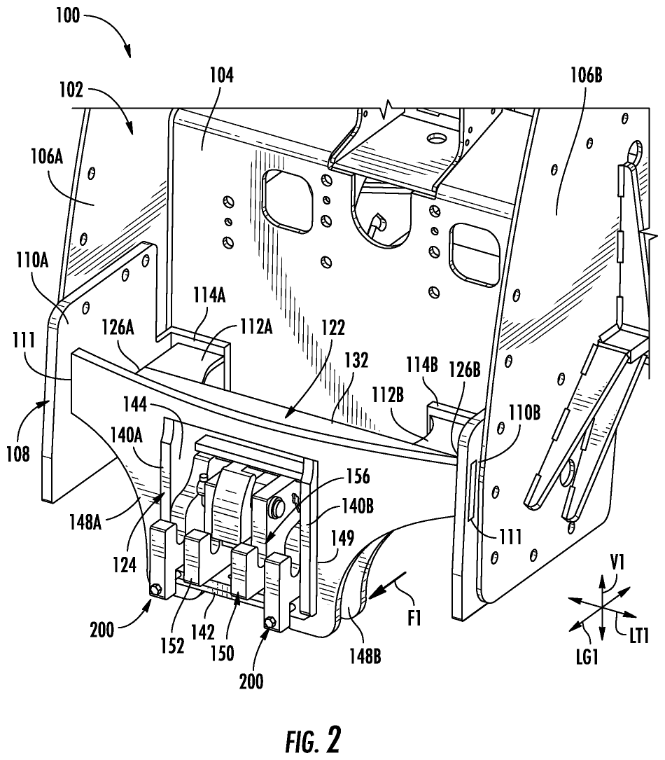

The work vehicle 10 may be generally configured to tow an implement. As such, the work vehicle 10 includes a drawbar 150 extending between a proximal end 152 and a distal end 154. The distal end 154 is generally configured to be couplable to the frame 16 of the work vehicle 10. The drawbar 150 includes an implement coupling structure 156 (FIGS. 2-4 and 6) at the proximal end 152, where the implement coupling structure 156 is configured to couple an implement to the drawbar 150 for towing with work vehicle 10 (FIG. 1). As will be described in greater detail below, the work vehicle 10 additionally includes a hitch or drawbar support assembly 100 at the aft or rear end 42 of the work vehicle relative to a forward direction of travel DT1, with the drawbar support assembly 100 being supported by the frame 16 (e.g., near a rear axle of the rear wheels 14). The drawbar support assembly 100 is generally configured to support the proximal end 152 of the drawbar 150.

Referring now to FIG. 2, a perspective view of a rear end of an agricultural work vehicle (e.g., the rear end 42 of the work vehicle 10) having an assembly (i.e., the drawbar support assembly 100) for supporting a drawbar of an agricultural work vehicle is illustrated in accordance with aspects of the present subject matter. As shown in FIG. 2, the drawbar support assembly 100 includes a rear plate 102 and a drawbar hanger 108. The rear plate 102 is mounted to the rear frame 16 (FIG. 1) proximate the rear end 42 (FIG. 1) of the work vehicle 10 (FIG. 1). The rear plate 102 includes a first wall 104 extending substantially along a lateral direction LT1, and two side walls 106, including a first or left sidewall 106A and a second or right sidewall 106B, extending rearwardly from the first wall 104 along a front-rear or longitudinal direction LG1 and perpendicular to the first wall 104. The drawbar hanger 108 is fixed to the rear plate 102. For instance, the drawbar hanger 108 includes a first or left support wall 110A and a second or right support wall 110B, each extending along the longitudinal direction LG1. The left support wall 110A is fixed or fixable to the left sidewall 106A of the rear plate 102 and the right support wall 110B is fixed or fixable to the right sidewall 106B of the rear plate 102. The left and right support walls 110A, 110B each include a support flange extending laterally outwardly therefrom. For example, the left support wall 110A has a left support flange 112A and the right support wall 110B has a right support flange 112B. The support flanges 112A, 112B extend in a horizontal plane defined by the longitudinal and lateral directions LG1, LT1. Additionally, in some embodiments, the drawbar hanger 108 includes a left secondary support wall 114A and a right secondary support wall 114B, each extending along the lateral direction LT1. The left secondary support wall 114A abuts against the first wall 104 proximate the left sidewall 106A and the right secondary support wall 114B abuts against the first wall 104 proximate the right sidewall 106B. In some embodiments, one or both of the secondary support walls 114A, 114B is coupled or coupleable to the first wall 104.

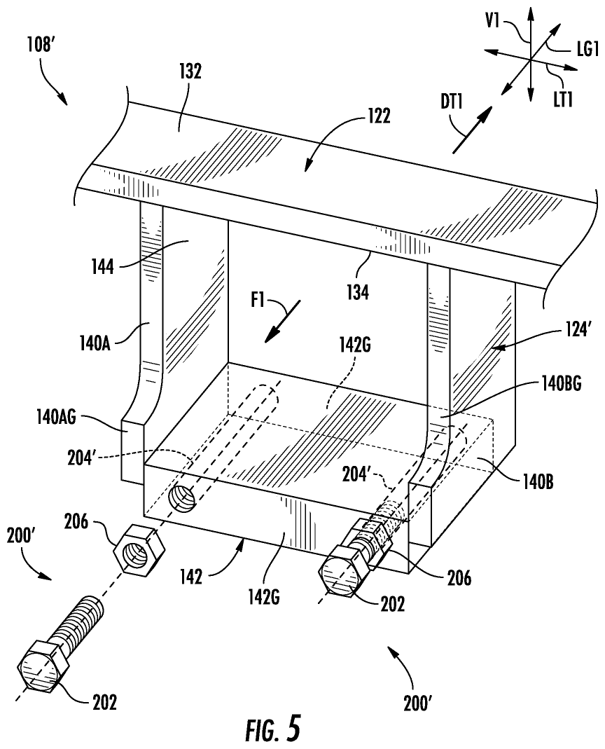

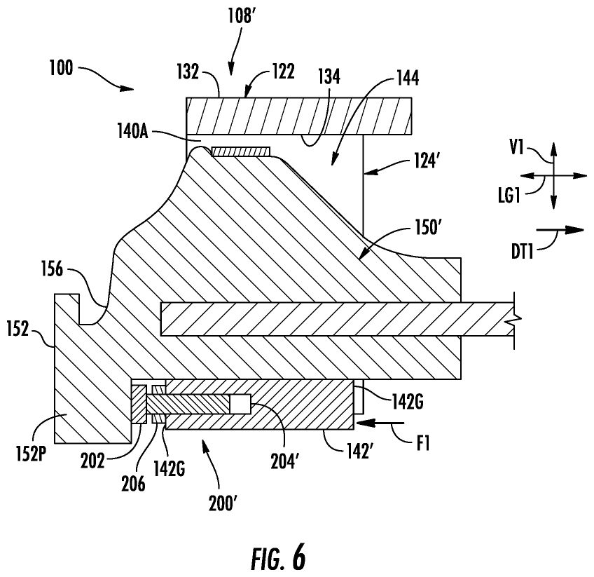

The drawbar hanger 108 further includes a bar support portion 122 and a saddle portion 124. The bar support portion 122 has a lateral width defined between a first or left lateral end 126A and a second or right lateral end 126B along the lateral direction LT1, and a thickness defined between an upper side 132 and a lower side 134 (FIGS. 5 and 6) along the vertical direction V1. The left lateral end 126A of the bar support portion 122 is coupled to the left support wall 110A while the right lateral end 126B of the bar support portion 122 is coupled to the right support wall 110B. For instance, in some embodiments, the left lateral end 126A of the bar support portion 122 is supported on the left support flange 112A, while the right lateral end 126B of the bar support portion 122 is supported on the right support flange 112B. The saddle portion 124 is fixable or fixed to the bar support portion 122 between the first and second lateral ends 126A, 126B of the bar support portion 122. For instance, in one embodiment, the saddle portion 124 is fixable or fixed to the lower side 134 of the bar support portion 122. Alternatively, in another embodiment, the saddle portion 124 is fixable or fixed to the upper side 132 of the bar support portion 122. However, it should be appreciated that the saddle portion 124 may be otherwise fixable or fixed to the bar support portion 122.

The saddle portion 124 is formed by a first saddle wall 140A, a second saddle wall 140B, and a bottom or third saddle wall 142 such that the saddle portion 124 has a u-shaped cross-section when viewed along the longitudinal direction LG1. For instance, the first and second saddle walls 140A, 140B extend along the longitudinal direction LG1 and are spaced apart in the lateral direction LT1 by the third saddle wall 142 extending along the lateral direction LT1, the third saddle wall 142 being coupled to a vertical end of the first and second saddle walls 140A, 140B along the vertical direction V1. The saddle portion 124 is fixable or fixed to the bar support portion 122 such that the saddle portion 124 is supported relative to frame 16 at least by the bar support portion 122. The saddle portion 124 is fixed or fixable to the bar support portion 122 such that an open side of the u-shaped cross-section, opposite the third saddle wall 142, is closest to the bar support portion 122. As such, an opening 144 is defined between the bar support portion 122 and the saddle portion 124 where the opening 144 is configured to receive the proximal end 152 of the drawbar 150 of the work vehicle 10 such that the implement coupling structure 156 is connectable to an implement.

Additionally, in some embodiments, the drawbar support assembly 100 includes one or more gusset members configured to help support the left and right sidewalls 106A, 106B of the rear plate 102 and the saddle portion 124 of the drawbar hanger 108. More particularly, in one embodiment, at least one first gusset member 148A extends from the first support wall 110A to the second support wall 110B in the lateral direction LT1 and defines an opening 149 in which the saddle portion 142 is received such that the first gusset member(s) 148A at least partially wraps around each of the saddle walls 140A, 140B, 142. In some instances, each of the lateral ends of the first gusset member(s) 148A may be received in a respective slot 111 defined in the respective support wall 110A, 110B. In one embodiment, the first gusset member(s) 148A extends higher than the bar support portion 122 and the saddle portion 124 in the vertical direction V1. In some embodiments, at least one pair of second gusset members 148B is similarly provided, where each of the pair of second gusset members 148B extends from a respective one of the first support wall 110A or the second support wall 110B in the lateral direction LT1 to the saddle portion 142. Each pair of second gusset members 148B together defines another opening 149 in which the saddle portion 142 is received such that the pair of second gusset members 148B together at least partially wraps around each of the saddle walls 140A, 140B, 142.

In some instances, when the work vehicle 10 is traveling in the forward direction of travel DT1, the drawbar hanger 108 may scrape or hit the ground and/or an implement (not shown) attached to the drawbar 150 may uncouple from the drawbar 150. In such instances, the ground and/or the implement (via a chain (not shown) coupled between the implement and the drawbar hanger 108) may apply a force F1 to the drawbar hanger 108 in a direction generally opposite the direction of travel DT1. The force F1 may create a moment about or torque through the drawbar hanger 108 that tilts the drawbar hanger 108 rearward and upward relative to the forward direction of travel DT1, which may damage the drawbar hanger 108. As such, as will be described in greater detail below, the drawbar support assembly 100 may additionally include one or more adjustable stop assemblies 200 to help protect the drawbar hanger 108 from such force F1.

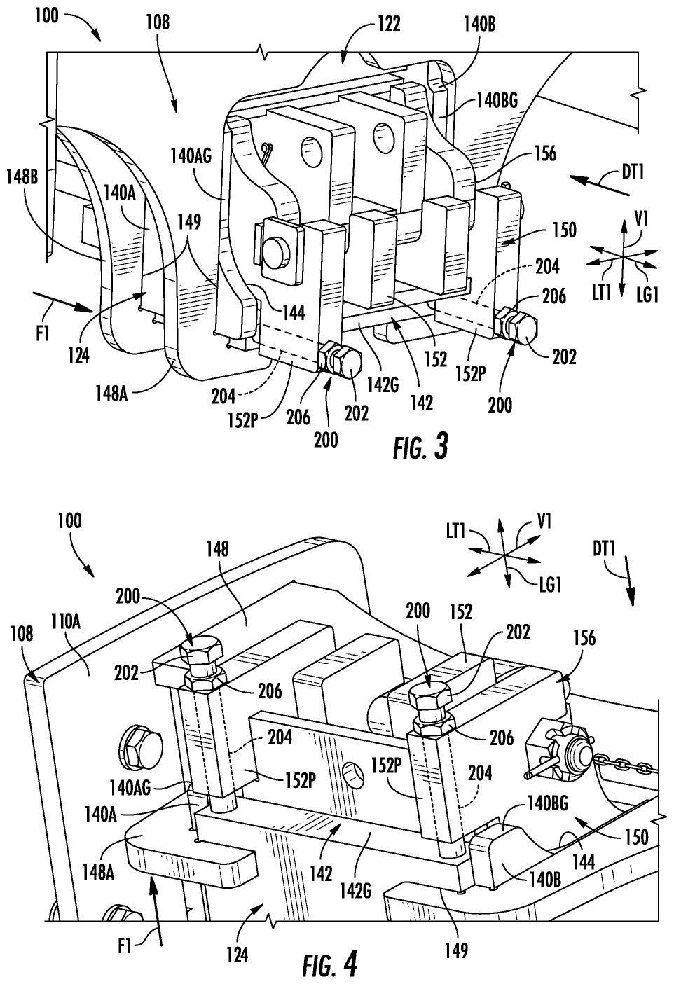

Referring now to FIGS. 3 and 4, additional perspective views of the drawbar support assembly 100 shown in FIG. 2 are illustrated in accordance with aspects of the present subject matter, particularly illustrating the drawbar 150 having adjustable stop assemblies 200 for supporting the drawbar hanger 108. In the embodiment shown in FIGS. 3 and 4, each of the adjustable stop assemblies 200 includes a stop member 202 configured to be received within a respective slot 204 defined in the proximal end 152 of the drawbar 150. The position of each of the stop members 202 within the respective slot 204 is variable such that the stop member 202 may be brought into contact with the drawbar hanger 108 when the drawbar 150 is received within the hanger 108. For instance, the slot(s) 204 and the stop member(s) 202 may be compatibly threaded, such that the length of the stop member(s) 202 protruding from the slot(s) 204 may be adjusted by selectively rotating the stop member(s) 202. The stop member(s) 202 may be configured as any suitable threaded fastener, such as a bolt, a screw, and/or the like. In some embodiments, each of the adjustable stop assemblies 200 may include a locking fastener 206 between at least a portion of the stop member(s) 202 and the slot(s) 204 to prevent the stop member(s) 202 from rotating relative to the slot(s) 204 due to vibrations during operation of the work vehicle 10. For instance, the locking fastener 206 may be a lock nut, a spring washer, and/or any other suitable fastener or combination of locking fasteners.

In one embodiment, each of the stop members 202 is configured to contact a longitudinal end surface of the drawbar hanger 108. For instance, the stop member(s) 202 may be configured to contact one of the longitudinal end surfaces 142G (one of which is shown in FIGS. 3 and 4) of the third saddle wall 142 of the saddle portion 124. For example, in some embodiments, such as shown in FIGS. 3 and 4, the slot(s) 204 are defined within one or more extension portions 152P of the proximal end 152 of the drawbar 150. In one embodiment, the extension portion(s) 152P extends downwardly in the vertical direction V1 relative to the opening 144 and at least partially overlaps with the longitudinal end surface 142G of the third saddle wall 142 of the saddle portion 124 in the vertical direction V1 and the lateral direction LT1 when the drawbar 150 is received within the opening 144.

The slot(s) 204 may extend substantially along and parallel to the longitudinal direction LG1 when the drawbar 150 is received within the hanger 108, such that the stop member(s) 202 is movable perpendicularly relative to the longitudinal end surface 142G of the third saddle wall 142 until it contacts the longitudinal end surface 142G. It should be appreciated that, instead of vertically and laterally overlapping with the longitudinal end surface 142G of the third saddle wall 142, the extension portion(s) 152P may instead, or additionally, at least partially vertically and laterally overlap with a longitudinal end surface 140AG of the first saddle wall 140A and/or a longitudinal end surface 140BG of the second saddle wall 140B in the vertical direction V1 and the lateral direction LT1, in which case, the stop member(s) 202 would be configured to be movable into contact with the longitudinal end surface 140AG of the first saddle wall 140A and/or the longitudinal end surface 140BG of the second saddle wall 140B.

In one embodiment, as shown, the slot(s) 204 extend through the entire longitudinal thickness of the extension portion(s) 152P in the longitudinal direction LG1. However, in other embodiments, the slot(s) 204 may only extend through part of the longitudinal thickness of the extension portion(s) 152P in the longitudinal direction LG1, with the slot(s) 204 extending into the longitudinal end of the portion(s) 152P closer to the hanger 108. In one embodiment, the extension portion(s) 152P may be integrally formed as part of the implement coupling structure 156 as shown in FIGS. 3 and 4. However, it should be appreciated that, in other embodiments, the extension portion(s) 152P may instead be separately formed and subsequently attached to the implement coupling structure 156. Additionally, it should be appreciated that, while only two extension portions 152P are shown, the drawbar 150 may have any other suitable number of extension portions 152P, such as one or three or more extension portions 152P.

The drawbar 150 may have any suitable number of adjustable stop assemblies 200. For instance, in some embodiments, the drawbar 150 includes two adjustable stop assemblies 200 spaced apart along the lateral direction LT1 so that the stop assemblies 200 do not create a torque force that causes the hanger 108 to additionally twist laterally (e.g., left or right). For example, the adjustable stop assemblies 200 may be at least approximately equidistant from a longitudinal central axis of the drawbar 150. However, the drawbar 150 may include any other suitable number of adjustable stop assemblies 200. For instance, the drawbar 150 may instead include only one stop assembly 200, or three or more stop assemblies 200.

The force F1 applied by the ground when the drawbar hanger 108 hits the ground and/or by an implement through the safety chain when the implement detaches from the drawbar 150′ while the work vehicle 10 is traveling in the forward direction of travel DT1 is transferred from the drawbar hanger 108 to the drawbar 150 via the adjustable stop assemblies 200. As such, the drawbar hanger 108 is prevented from torque-related damage derived from ground contact or drag forces from the implement. Additionally, because the position of the stop members 202 of the stop assemblies 200 is adjustable, the drawbar hanger 108 and the drawbar 150 may be in contact, or closer to contact, with each other before a ground impact or implement drag forces regardless of differences in manufacturing or assembly tolerances, which further reduces the potential for damage to the drawbar hanger 108.

In one embodiment, instead of the adjustable stop assemblies 200 being part of the drawbar 150, one or more adjustable stop assemblies 200′ may instead be part of a hanger 108′. For instance, referring now to FIGS. 5 and 6, differing views of another embodiment of a drawbar support assembly 100′ are illustrated, where the drawbar hanger 108′ shown in FIGS. 5 and 6 is substantially the same as the drawbar hanger 108 shown in FIGS. 2-4, except that the hanger 108′ in FIGS. 5 and 6 is configured with adjustable stop assemblies 200′. Each of the adjustable stop assemblies 200′ shown in FIGS. 5 and 6 is substantially the same as the adjustable stop assemblies 200 described above with reference to FIGS. 2-4, except that the slot(s) 204′ of the assemblies 200′ are defined within the hanger 108′ instead of being defined within the drawbar 150′. In such embodiment, each of the stop member(s) 202 is brought into contact with the drawbar 150′.

For example, in one embodiment, as shown in FIGS. 5 and 6, the slot(s) 204′ are defined within the third saddle wall 142′ of the saddle portion 124′ of the hanger 108′. The slot(s) 204′ may extend substantially along and parallel to the longitudinal direction LG1. In one embodiment, the slot(s) 204′ only extend through part of the width of the saddle wall 142 of the hanger 108′ in the longitudinal direction LG1 and open to only one of the longitudinal end surfaces 142G of the third saddle wall 142 (i.e., to the longitudinal end surface 142G closer to the proximal end 152 of the drawbar 150′). However, it should be appreciated that, in another embodiment, the slot(s) 204′ may extend through the entire width of the third saddle wall 142 of the hanger 108′ in the longitudinal direction LG1 and open to both longitudinal end surfaces 142G of the third saddle wall 142.

The position of each of the stop members 202 within the respective slot 204′ is variable such that the stop member(s) 202 may be brought into contact with the drawbar 150′ when the drawbar 150′ is received within the hanger 108′ (FIG. 6). For instance, the stop member(s) 202 may be movable into contact with the extension portion(s) 152P of the drawbar 150′ overlapping the third saddle wall 142. The slot(s) 204′ and the stop member(s) 202 may be compatibly threaded, such that the length of the stop member(s) 202 protruding from the slot(s) 204′ may be adjusted by rotating the stop member(s) 202. In some embodiments, each of the adjustable stop assemblies 200′ may also include a locking fastener 206 between at least a portion of the stop member(s) 202 and the slot(s) 204′ to prevent the stop member(s) 202 from rotating due to vibrations during operation of the work vehicle 10.

It should be appreciated that the slot(s) 204′ may instead or additionally be defined in any other suitable part of the drawbar hanger 108′. For instance, the slot(s) 204′ may instead or additionally be defined in the longitudinal end surface 140AG of the first saddle wall 140A and/or the longitudinal end surface 140BG of the second saddle wall 140B, in which case the extension portion(s) 152P of the drawbar 150′ would instead or additionally overlap longitudinal end surface 140AG of the first saddle wall 140A and/or the longitudinal end surface 140BG of the second saddle wall 140B.

The hanger 108′ may have any suitable number of adjustable stop assemblies 200. For instance, in some embodiments, the hanger 108′ includes two adjustable stop assemblies 200 spaced apart along the lateral direction LT1 such that the adjustable stop assemblies 200 are at least approximately equidistant from a longitudinal central axis of the hanger 108′ so that the stop assemblies 200 do not create a torque force that causes the hanger 108′ to additionally twist left or right. However, the hanger 108′ may include any other suitable number of adjustable stop assemblies 200. For instance, the hanger 108′ may instead include only one stop assembly 200, or three or more stop assemblies 200.

Similar to the stop assemblies 200, the force F1 applied to the drawbar hanger 108′ by the ground when the drawbar hanger 108′ hits the ground or by an implement via a safety chain when the implement uncouples from the drawbar 150′ while the work vehicle 10 is traveling in the forward direction of travel DT1 is transferred from the drawbar hanger 108′ to the drawbar 150′ via the adjustable stop assemblies 200′. As such, the drawbar hanger 108′ is prevented from torque-related damage derived from ground contact or implement drag forces. It should further be appreciated that, because the position of the stop members 202 of the stop assemblies 200′ is adjustable, the drawbar hanger 108′ and the drawbar 150′ may be in contact, or closer to contact, with each other before a ground impact or implement drag forces regardless of differences in manufacturing or assembly tolerances, which further reduces the potential for damage to the drawbar hanger 108′.

It should be appreciated that the extension portion(s) 152P of the drawbar 150, 150′ used alone, without the stop member(s) 202, may also provide some protection against torque of the drawbar hanger 108, 108′ as the extension portion(s) 152P may limit how far the drawbar hanger 108, 108′ may torque rearward and upward before transmitting at least some of the force F1 to the drawbar 150, 150′. Additionally, it should be appreciated that due to the reduced torque on the drawbar hanger 108, 108′ when the extension portion(s) 152P and/or the stop assemblies 200, 200′ are present, the drawbar hanger 108, 108′ may not require the gusset members 148A, 148B (FIG. 5 shows one example of the drawbar hanger 108′ without gusset members) and/or may be made with thinner and/or lighter materials than without the stop assemblies 200, 200′.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural system for supporting a drawbar of an agricultural vehicle, the agricultural system comprising:
a drawbar hanger couplable to a rear frame of the agricultural vehicle, the drawbar hanger defining an opening along a longitudinal direction;
a drawbar extending between a proximal end and a distal end along the longitudinal direction, the proximal end being receivable in the opening defined by the drawbar hanger, the distal end being couplable to the rear frame; and
an adjustable stop member receivable within a slot defined within one of the drawbar hanger or the drawbar, the adjustable stop member being selectively movable within the slot to allow the adjustable stop member to be brought into contact with the other of the drawbar hanger or the drawbar.

2. The agricultural system of claim 1, wherein the proximal end of the drawbar has an extension portion that at least partially overlaps a longitudinal end surface of the drawbar hanger in both a lateral direction and a vertical direction.

3. The agricultural system of claim 2, wherein the drawbar hanger comprises a bar support portion and a saddle portion, the opening being defined between the bar support portion and the saddle portion, the longitudinal end surface being part of a bottom saddle wall of the saddle portion.

4. The agricultural system of claim 1, wherein the slot extends along the longitudinal direction.

5. The agricultural system of claim 1, wherein the slot is defined within the proximal end of the drawbar, the adjustable stop member being selectively movable within the slot to allow the adjustable stop member to be brought into contact with the drawbar hanger.

6. The agricultural system of claim 1, wherein the slot is defined within the drawbar hanger, the adjustable stop member being selectively movable within the slot to allow the adjustable stop member to be brought into contact with the proximal end of the drawbar.

7. The agricultural system of claim 1, wherein the drawbar hanger comprises a bar support portion and a saddle portion, the opening being defined between the bar support portion and the saddle portion,
the agricultural system further comprising a gusset member, the gusset member being configured to at least partially receive the saddle portion.

8. The agricultural system of claim 7, wherein the bar support portion extends along a lateral direction between a first support wall and a second support wall of the drawbar hanger,
wherein the gusset member extends from the saddle portion to at least one of the first support wall or the second support wall.

9. The agricultural system of claim 1, further comprising a locking fastener between at least a portion of the adjustable stop member and the slot, the locking fastener preventing the adjustable stop member from moving relative to the slot due to vibration of the agricultural vehicle.

10. An assembly for supporting a drawbar of an agricultural vehicle, the assembly comprising:
a drawbar hanger configured to be fixed relative to a rear frame of the agricultural vehicle, the drawbar hanger comprising a bar support portion and a saddle portion, the saddle portion being fixed to the bar support portion such that an opening along a longitudinal direction is formed between the saddle portion and the bar support portion for receiving a drawbar of the agricultural vehicle; and
an adjustable stop member receivable within a slot defined within the saddle portion, the adjustable stop member being selectively movable within the slot to allow the adjustable stop member to be brought into contact with a drawbar when a drawbar is received within the opening.

11. The assembly of claim 10, wherein the slot is defined in a longitudinal end surface of the saddle portion, the longitudinal end surface of the saddle portion at least partially overlaps a drawbar in both a lateral direction and a vertical direction when a drawbar is received within the opening.

12. The assembly of claim 11, wherein the longitudinal end surface is part of a bottom saddle wall of the saddle portion.

13. The assembly of claim 10, wherein the slot extends along the longitudinal direction.

14. The assembly of claim 10, further comprising a gusset member, the gusset member being configured to at least partially receive the saddle portion.

15. The assembly of claim 14, wherein the bar support portion extends along a lateral direction between a first support wall and a second support wall of the drawbar hanger,
wherein the gusset member extends from the saddle portion to at least one of the first support wall or the second support wall.

16. The assembly of claim 10, further comprising a locking fastener between at least a portion of the adjustable stop member and the slot, the locking fastener preventing the adjustable stop member from moving relative to the slot due to vibration of the agricultural vehicle.

17. An agricultural system for supporting a drawbar of an agricultural vehicle, the agricultural system comprising:
a drawbar hanger coupled to a rear frame of the agricultural vehicle, the drawbar hanger comprising a bar support portion and a saddle portion, the saddle portion being fixed to the bar support portion such that an opening is formed along a longitudinal direction between the saddle portion and the bar support portion; and
a drawbar extending between a proximal end and a distal end along the longitudinal direction, the proximal end being receivable in the opening formed between the saddle portion and the bar support portion, and the distal end being couplable to the rear frame,
wherein the proximal end of the drawbar at least partially overlaps a longitudinal end surface of the drawbar hanger in both a lateral direction and a vertical direction.

18. The agricultural system of claim 17, further comprising an adjustable stop member receivable within a slot defined within one of the saddle portion or the proximal end of the drawbar or, the adjustable stop member being selectively movable within the slot to allow the adjustable stop member to be brought into contact with the other of the saddle portion or the proximal end of the drawbar.

19. The agricultural system of claim 17, wherein the longitudinal end surface is part of a bottom saddle wall of the saddle portion.
